(19) United States
(12) Patent Application Publication
(10) Pub. No.: US 2018/0041749 A1
(43) Pub. Date: Feb. 8, 2018

(54) METHOD AND APPARATUS FOR STIMULATING STEREOSCOPIC DEPTH PERCEPTION OF STEREOSCOPIC DATA INSIDE HEAD MOUNTED DISPLAYS WHEN VIEWING PANORAMIC IMMERSIVE STEREOSCOPIC CONTENT

(71) Applicant: Thomas Seidl, Kahului, HI (US)

(72) Inventor: Thomas Seidl, Kahului, HI (US)

(21) Appl. No.: 15/668,661

(22) Filed: Aug. 3, 2017

Related U.S. Application Data
(60) Provisional application No. 62/370,985, filed on Aug. 4, 2016.

(51) Int. Cl. H04N 13/02; H04N 13/04; H04N 13/00

(52) U.S. Cl. CPC H04N 13/0275; H04N 13/0055; H04N 13/044; H04N 13/0011; G02B 2027/0134

(57) ABSTRACT

Apparatuses and methods are provided that stimulate realistic 3D depth perception from 3D image data. The solution helps the brain perceive a more realistic depth by placing an object, which may or may not be transparent, in virtual 3D space such that the object appears close to the user inside the panoramic viewer in order to give the brain a close point to reference in 3D space where it might normally struggle to perceive depth at the border of two opposing perceptions of 3D depth for the brain.

### CROSS-REFERENCE TO RELATED APPLICATIONS

This application claims the benefit of U.S. Provisional Patent Application No. 62/370,985, filed Aug. 4, 2016, incorporated herein by reference.

### SUMMARY OF THE INVENTION

The purpose of the invention/method is to stimulate stereoscopic depth perception to the user when, but not always limited to, viewing immersive 360×360 3D video inside a head mounted display (HMD). A variety of angles can be covered such as viewing a hemisphere referred to as 90×360 degrees or 1.80×360 if 360×360 is considered the full sphere. Video may be shot with a camera as featured in U.S. Pat. No. 9,007,430, incorporated herein by reference. Images and figures shown may be computer simulated to show rough details. Typically, when a mask is applied to the lens surface, the edge of the mask will be more blurred than shown in the drawings.

The present invention solves a problem that arises when stitching together images in a stereoscopic panoramic image of an immersive 3D 360 image or video. Traditionally, images are blended together from different camera viewpoints to make a seamless panoramic image. When using a 2D 360 image format, this process works very well from multiple camera viewpoints, but when stitching a 3D 360 image, there are times when images are blending in 3D space rather than just 2D 360. This causes a problem for users and will induce a headache in cases where 3D objects are close to the camera. Embodiments of the present invention aid the stitching in 3D space by semi obscuring the 3D join/stich/blend between camera viewpoints with a mask/object. This provides the user a 3D reference point that is computer generated to aid the user's interpretation of the 3D virtual environment. A further step uses the captured 360 3D image dynamically light and computer generate the mask that is placed over the image. The object will then look like it is correctly lit for the virtual environment.

### BRIEF DESCRIPTION OF THE DRAWINGS

FIG. 1 shows a fisheye lens front view with a filter located around its outer periphery.

FIG. 2 shows several semitransparent masks located in a fisheye lens.

FIG. 3 shows a Fisheye with gradient filter.

FIG. 4 is a panoramic picture without an overlay.

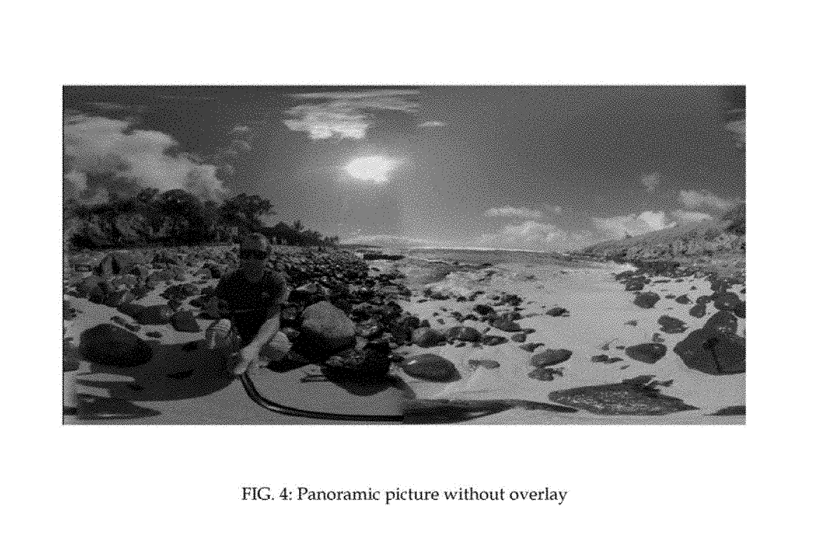

FIG. 5 is a fisheye having an irregular shaped mask.

FIG. 6 is a fisheye with a semi mask.

FIG. 7 is a fisheye with a mask.

FIG. 8 is a fisheye without a mask.

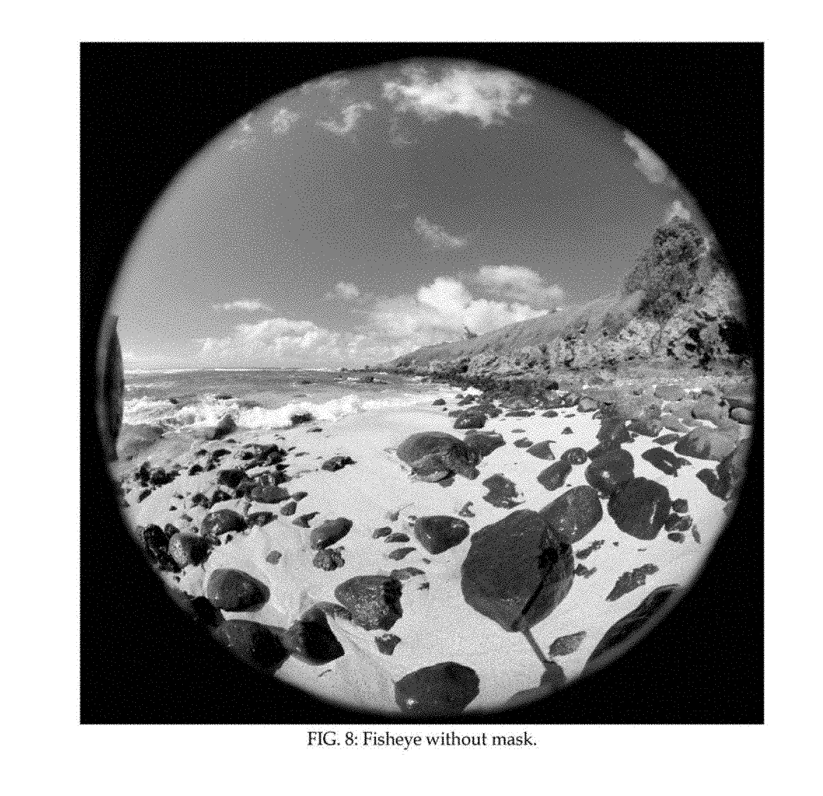

FIG. 9 shows a possible border in a stereo viewer. This is close to the end result. The video is from inside a HMD.

FIG. 10 shows an overlay on a panoramic equirectangular image. In over stereo under format. Overlay could also be used on a side by side stereo format and also could be used in a variety of other formats.

FIG. 11 shows an alternative filter location.

FIG. 12 shows an example of an attached solid mask. This is not typical mask. In most cases the mask would be transparent. The figure shows how it can be used primarily as a sun shade to stop lens flare.

### DETAILED DESCRIPTION OF THE INVENTION

To stimulate realistic 3D depth perception, part of the image viewed inside an HMD is created by semi obscuring part of the video. The present inventor postulates that this causes the user's brain to “fill in the blanks” and create a more realistic user experience when the user views the image around where two opposing perceptions of 3D depth for the brain meet around the edge or close to the joins between the source wide angled images. The brain is amazing in the way it can interpret stereoscopic data from each eye/lens. It can adapt to a variety of situations. For example, when viewing in mirrors, through poor misaligned sunglasses or cracked windscreens, the brain assumes the missing parts or adjusts for “nonstandard” materials it has to view through. Most of these alternate ways to interpret 3D data were learned as a child, but the brain is always willing to learn and adapt. The present inventor has discovered that these “viewing defects” help humans to modify and adapt how their brain sees depth perception through objects. Again, this process is learned from an early age.

The present inventor has discovered that the brain needs to follow some basic rules, because even the brain can be confused with some 3D image data, which confusion prevents the brain from processing the data in a logical manner for depth perception. It appears some adjustment corrections are just too complicated for the brain, causing it to lose depth perception, which results in a nonrealistic interpretation of the environment. The present invention provides embodiments of apparatuses and methods that stimulate realistic 3D depth perception from 3D image data. This present invention and disclosure will provide a solution to help the brain perceive a more realistic depth by placing an object, which may or may not be transparent, in virtual 3D space such that the object appears close to the user inside the panoramic viewer in order to give the brain a close point to reference in 3D space where it might normally struggle to perceive depth at the border of two opposing perceptions of 3D depth for the brain. It can also act as a fixed point in the video to help stabilize the user when dealing with a lot of movement. If the object is semitransparent, the brain is left to assume the light is bent in a certain way through the object and amazingly corrects for the distortion at this point in the virtual environment and does not challenge the depth perception errors.

In software, the mask bar discussed herein can also be used as a control panel to select different videos and change settings like volume. This is similar to a menu bar beneath a video player. In software or hardware, the mask bar does not have to be transparent. It can be solid. Further, in software, with the use of real time lighting and reflections by the panoramic software viewer, the bar can appear to become part of the scene recorded by the lighting and reflection code, utilizing the stereoscopic panoramic video that may be recorded as in a camera as seen in the incorporated patent. This allows the bar to appear to have correct lighting for the virtual environment. In more detail, it can be carried out, e.g., by moving or manipulating the panoramic image data captured by the camera to simulate a reflection or lighting. Using the positional head tracking data on a HMD, the reflections and lighting can simulate the reflection as in the real world at that specific point in time of the video. This can be accomplished by utilizing standard movement and ray tracing code within a 3D virtual space, to simulate how each eye would perceive the reflection and lighting in the real world on the mask bar. The mask bar also may have features on it such as appears to have a curved surface. The end result is the bar will fit seamlessly into the virtual environment created inside the HMD for the user, making the virtual environment look more realistic.

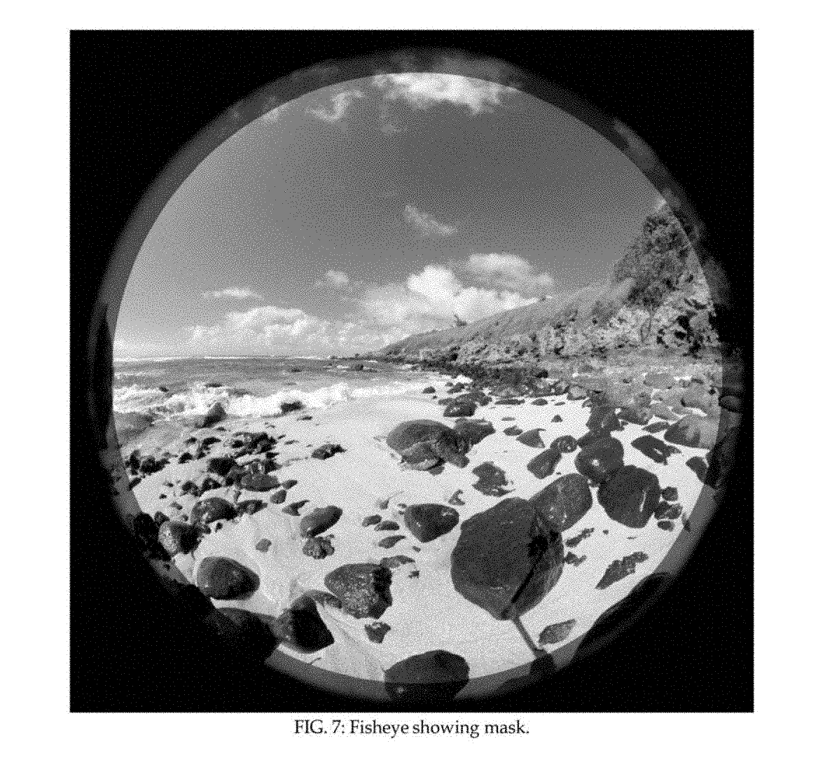

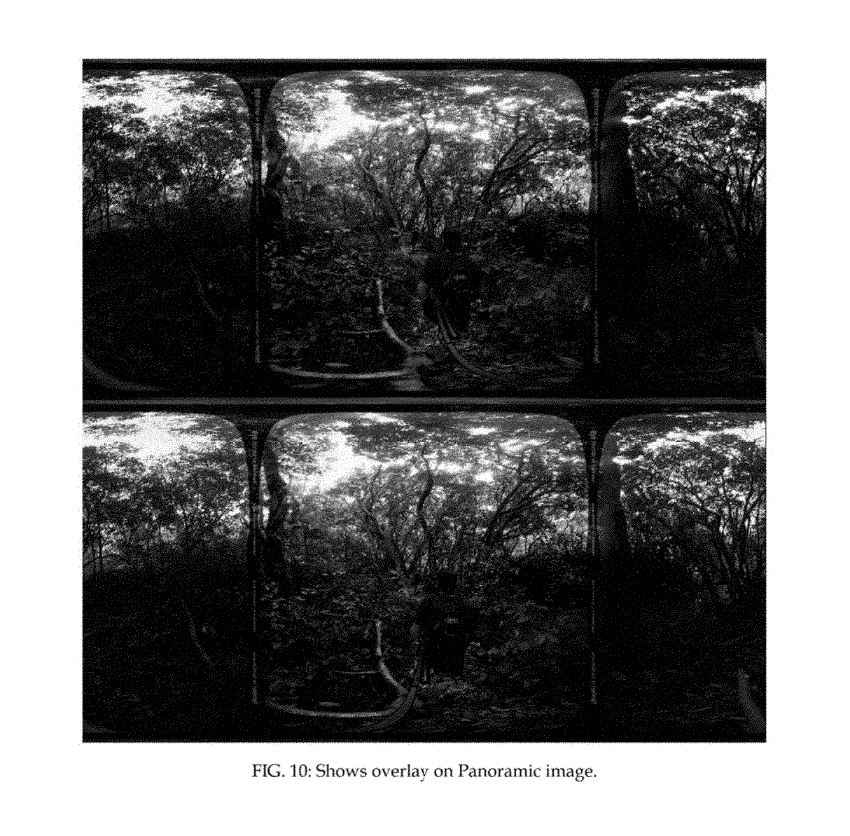

The invention can be carried out in hardware, e.g., as shown in FIG. 7 (showing as seen by camera) or in software, e.g., as in FIG. 10. In hardware, this could be done with, but not limited to, a semitransparent coating, material, stained glass, thin film layer or plastic material used around the lens covering up to 360 degree FOV, but typically up to 25 degrees around the outside of the image/lens or placed in a fashion to darken the joins of the different fisheye images when combining them in stitching. The advantage of doing this in hardware is that the semitransparent coating can also help to stop or reduce lens flare. When combined with tilting the camera forward and hence tilting the camera lens forward, this eliminates any lens flare in the forward direction of the users view.

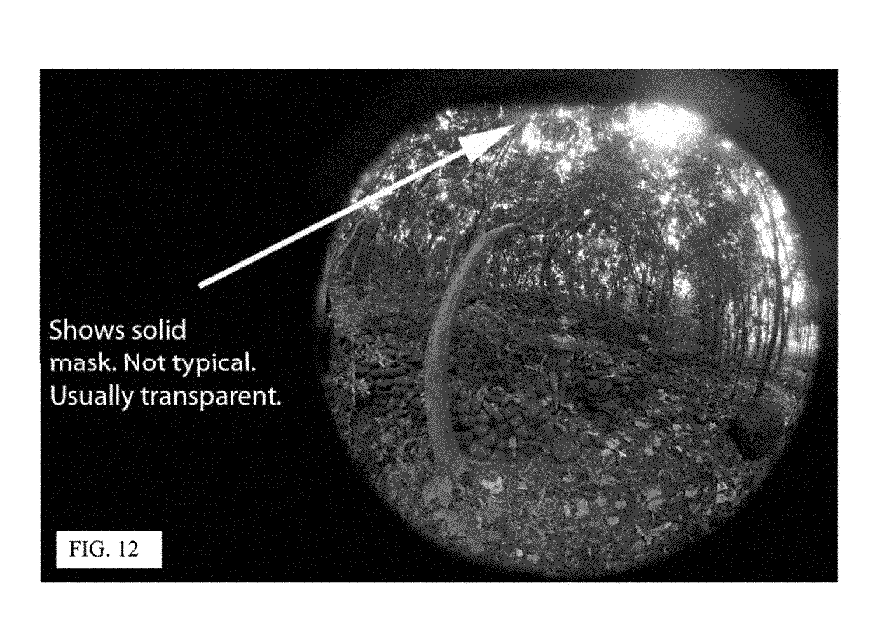

A combination of both hardware and software can be used also on the final image as the edge of the hardware mask can seem faded as on FIG. 12. The edge can be made less soft to resemble the mask image in FIG. 10.

### Hardware Mask

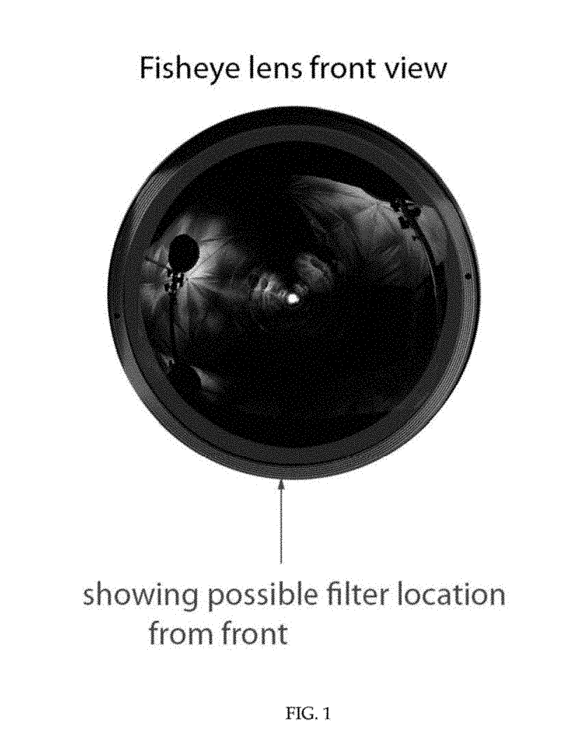

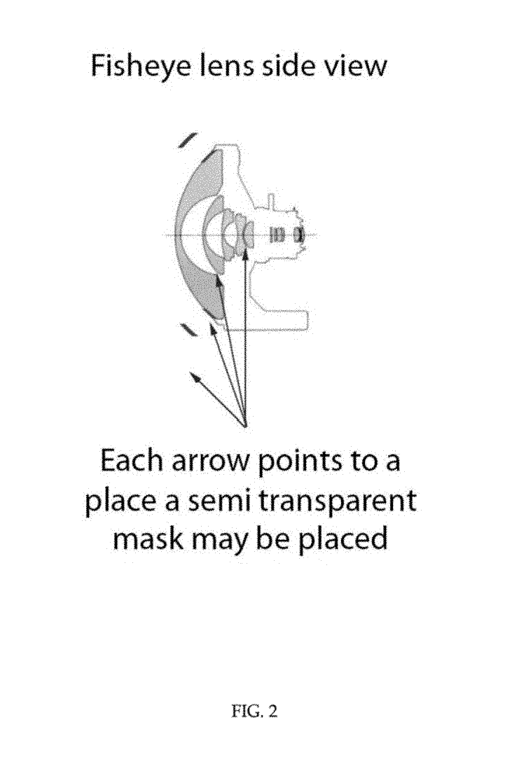

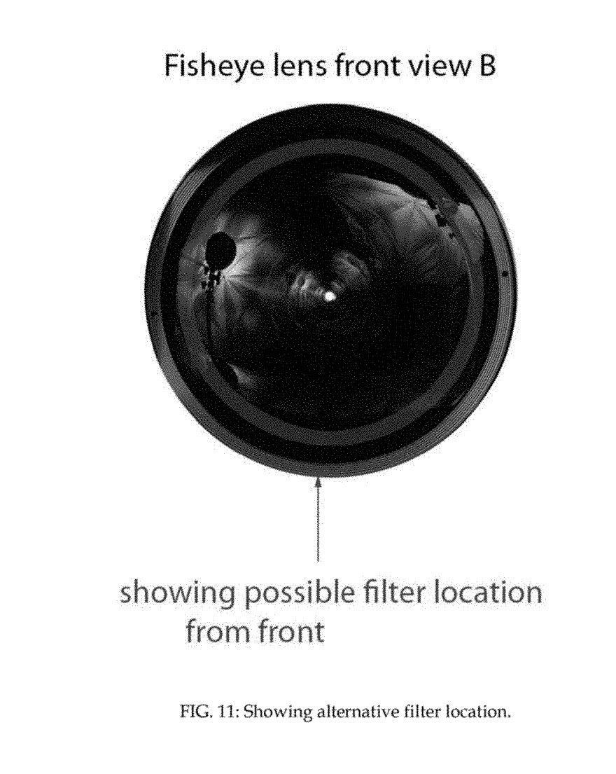

1. The hardware mask can be on the front optic of the fisheye lens or anywhere in the optical elements as in FIG. 1, FIG. 2, FIG. 11 and FIG. 12.

2. The hardware mask can cover the FOV for as much as 350 degrees but typically 25 degrees from the outside of the lens in or placed in a fashion to darken the joins of the different fisheye images when combining them in stitching

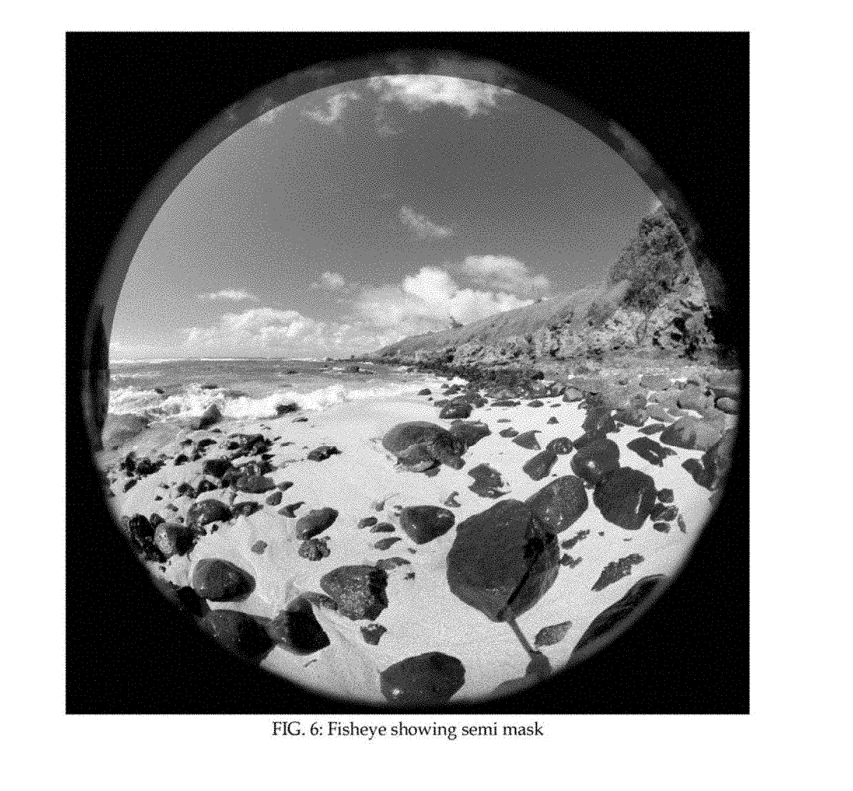

3. The hardware mask can be round the full edge of the lens as in FIG. 7 or could be partial similar FIG. 6 and FIG. 12.

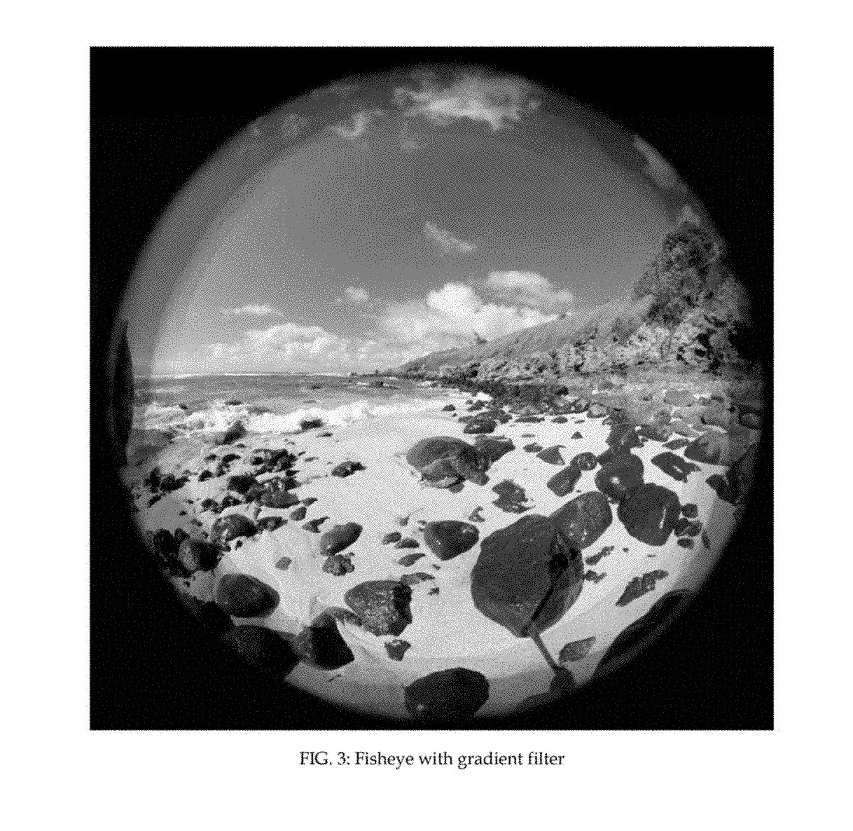

4. The hardware mask can have gradient as in FIG. 3.

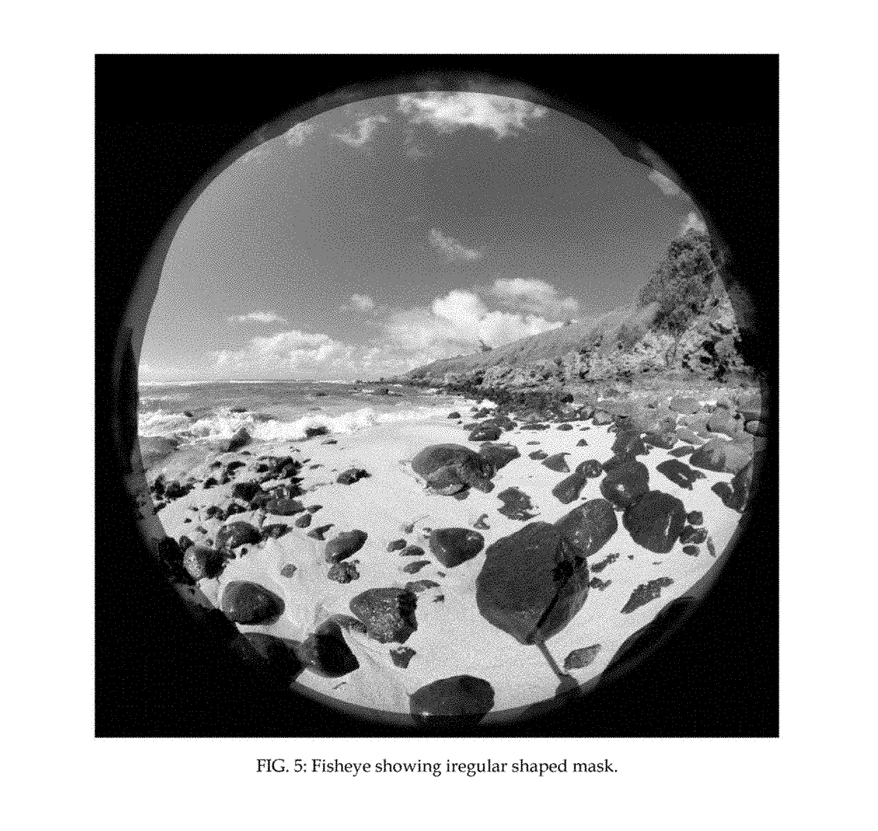

5. The hardware mask can be irregular as in FIG. 5 and FIG. 12.

6. The mask is typically used only on lenses that have a horizontal or vertical FOV that covers more than 90 degrees on both the horizontal and vertical access.

### Software Mask

The end result will produce a virtual shape or object within 3D virtual space that will mask the errors in depth perception where necessary. The mask could be placed, e.g., at the joins between different lenses or somewhere within the 360×360×3D virtual space.

The software mask can be done in several ways. Exemplary methods are:

1. The software mask can be applied, e.g., in video editing by overlaying a black semitransparent layer. Similar to the black overlay pictured in FIG. 10. The black layer can be over laid but not exclusively over the join between the two fisheye images. As in FIG. 10, the black overlay can be generated by taking a normal flat image, in this case a line with a slight bulge, to hide the lens that was saved as a tiff image. This line then was converted into a equi-rectangular projection resulting in the new black border layer. In FIG. 10 you will see the border has been moved by approximately 2% of the image width horizontally in the lower portion of the image in relation to the top mask. This is important to place the image in 3D space for the viewer. The semitransparent layer can be an irregular shape and can also have a gradual fade.

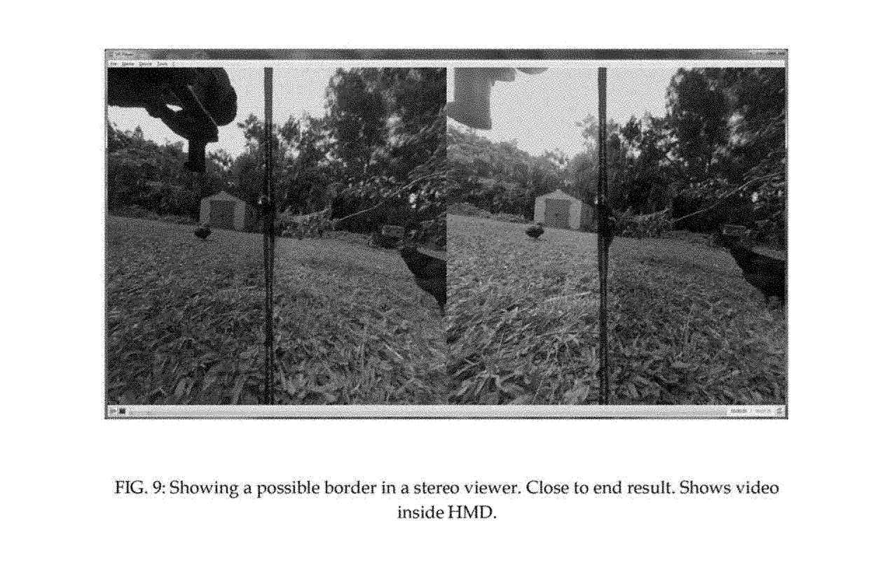

2. The software mask can be applied live by overlaying in real time inside the player software. This could look like FIG. 9 to the viewer. The mask can be rendered by placing the mask with a small offset between each viewing window for each eye. This is done by wrapping the mask with a few degrees horizontal angle offset around the rendered object for that eye in the viewer, creating 3D depth for the user to perceive. The bar can also be made more part of the virtual scene by adding reflections and lighting as detailed above.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

I claim:

1. An apparatus, comprising:
a fisheye lens; and
a mask applied to a field of view near the periphery of said fisheye lens.

2. The apparatus of claim 1, wherein said mask comprises hardware.

3. The apparatus of claim 1, wherein said mask is applied via software.

4. The apparatus of claim 1, wherein said mask is a combination of both hardware and software.

5. A method, comprising:
providing a fisheye lens; and
applying a mask to a field of view near the periphery of said fisheye lens.

6. The method of claim 5, wherein said mask comprises hardware.

7. The method of claim 5, wherein said mask is applied via software.

8. The method of claim 5, wherein said mask is a combination of both hardware and software.

9. A method, comprising:
providing the apparatus of any one of claim 1; and
utilizing said apparatus to record video data.
